(19) United States
(12) Patent Application Publication
(10) Pub. No.: US 2004/0091012 A1
(43) Pub. Date: May 13, 2004

(54) Apparatus for compressing the bandwidth of a light beam

(75) Inventor: Alois Herkommer, Aalen (DE)

Correspondence Address: SUGHRUE MION, PLLC, 2100 Pennsylvania Avenue, NW, Washington, DC, 20037-3213, US

(73) Assignee: CARL ZEISS LASER OPTICS GMBH

(21) Appl. No.: 10/420,912

(22) Filed: Apr. 23, 2003

(30) Foreign Application Priority Data
Apr. 25, 2002 (DE) 102 19 547.1

(51) Int. Cl. H01S 3/08

(52) U.S. Cl. 372/102

(57) ABSTRACT

Apparatus for narrowing the bandwidth of a light beam.

The invention relates to an apparatus for narrowing the bandwidth of a light beam for at least one frequency or wavelength which can be predetermined, having a diffraction grating (3) for the predetermined frequency or wavelength and having light beam guidance means (1, 2) in order to point an incident light beam (4) at the diffraction grating.

According to the invention, the diffraction grating is formed from two or more grating elements for the predetermined frequency or wavelength, and/or the light beam guidance means are designed to split the light beam into two or more beam elements (4a, 4b) and to point them at the diffraction grating such that they at least partially overlap in the grating longitudinal direction, with the beam elements being offset in the grating transverse direction and/or being polarised differently and/or striking the diffraction grating at incidence angles which correspond to different diffraction orders, for bandwidth narrowing with respect to the same predetermined frequency or wavelength.

Use, for example, in excimer lasers which emit UV radiation, for lithography systems for wafer structuring.

The invention relates to an apparatus for narrowing the bandwidth, that is to say for narrowing the frequency bandwidth or equivalently the wavelength bandwidth, of a light beam according to the preamble of Claim 1.

Apparatuses such as these are used, for example, for lasers and in particular for excimer lasers, in order to produce a laser beam with as narrow a frequency or wavelength bandwidth as possible, also referred to for simplicity in the present document as the bandwidth. The diffraction grating is used for frequency or wavelength selection using the diffraction effect. An Echelle grating, which operates in reflection, is frequently used for this purpose, in a Littrow configuration. The light beam guidance means are used to point the light beam whose bandwidth is to be narrowed, such as a laser beam coming from a laser amplification medium, in a suitable way at the diffraction grating, and to pass on in a suitable manner the light beam, which has been diffracted by this on a frequency-selective or wavelength-selective basis, for example to pass it back to the laser amplification medium. It frequently contains a beam widening system, which is arranged in front of the diffraction grating.

Typical conventional apparatuses for narrowing the bandwidth of a laser beam by means of diffraction gratings, such as Echelle gratings, and beam widening systems are described in the Patent Specifications U.S. Pat. No. 5,946,337, U.S. Pat. No. 5,978,409 and U.S. Pat. No. 5,917,849. A configuration of the light beam guidance means using a λ/4 plate and a suitable mirror is proposed in the last-mentioned patent specification, such that the laser beam is pointed at the diffraction grating by multiple reflection twice or even more in a circular-polarised state, before it is passed back to the laser amplification medium.

Apparatuses for narrowing the bandwidth of laser beams are used, for example, for excimer lasers, which are used in lithography systems for wafer structuring and for semiconductor chip production, and which emit light in the normal UV band (for example in the wavelength band around 250 nm) or in the deep UV band (in particular in the wavelength band between 150 nm and 200 nm). Limiting factors for the achievable narrowband nature of the laser light are in particular the finite divergence of the laser radiation in the laser resonator, and hence the angle blurring of the laser light which is incident on the diffraction grating and the diffraction-limited angular resolution of the grating, which is inversely proportional to the effective grating length. In the case of excimer lasers, the laser beam divergence is relatively large, typically in the order of magnitude of 1 mrad, owing to the finite size of the apertures for beam limiting and the small number of beam reversals in the resonator. Although it is reduced by the factor of the beam widening when a beam widening system is present, for example typically by a factor of 20 to values in the order of magnitude of 50 mrad at the diffraction grating, the beam widening on the other hand makes it necessary to use correspondingly large grating lengths of typically more than 200 nm, however, on the other hand, if, for example, the aim is produce ultra-narrowband laser radiation with a bandwidth of less than 1 pm for the predetermined selected wavelength, and these are complex to manufacture as full-periodic gratings.

Apparatuses for narrowing the bandwidth of a laser beam are also known in embodiments in which the narrowing of the bandwidth of the light beam is not just carried out for one frequency or wavelength, but for two or more predetermined frequencies or wavelengths. In this context, the Laid-Open Specification DE 40 15 861 A1 proposes that in each case one reflective diffraction grating, in a Littrow arrangement, be used, located alongside one another, for two different wavelengths. The Laid-Open Specification WO 88/08631 A1 proposes the arrangement of an associated diffraction grating, in order to select in each case one of two or more different spectral lines of a pulsed laser beam, such that it can optionally be introduced into the beam path, for example by positioning on a wheel which can be rotated or using a rotating mirror arrangement, which optionally points the laser beam at one of the diffraction gratings, which are selective for the various wavelengths. Alternatively, rotating mirror arrangements are proposed which optionally point the laser beam at different angles at an individual diffraction grating in order to select in each case one of two or more different wavelengths. The Laid-Open Specification DE 43 01 715 A1 proposes that, in order to narrow the bandwidth at two different wavelengths, a laser beam be split into two beam elements which are pointed without any overlap at two different angles at two different areas of a diffraction grating.

The invention is based on the technical problem of providing an apparatus of the type mentioned initially, by means of which the bandwidth of a light beam can be narrowed comparatively effectively for a frequency or wavelength which can in each case be predetermined, with relatively little complexity.

The invention solves this problem by providing an apparatus for narrowing the bandwidth of a light beam and having the features of Claim 1. This apparatus contains one or more measures which, depending on the application, can be implemented individually or in any desired combination and allow the use of a diffraction grating which can be produced comparatively easily, without this significantly adversely affecting the bandwidth narrowing behaviour of the apparatus in comparison to the comparable conventional apparatuses.

As one such measure, the diffraction grating can be formed from two or more grating elements in the grating longitudinal direction, with grating structure periodicities which are independent of one another for the same frequency or wavelength, that is to say the grating structures of different grating elements do not need to have a fixed phase relationship with one another. In consequence, although the diffraction-limited resolution capability of the grating is correspondingly reduced, it is evident, however, that this has no disadvantageous effects on the achievable bandwidth in most applications since this is also then generally still limited by the beam divergence. The two or more grating elements for the same desired frequency or wavelength can be produced considerably more easily than a standard grating with a continuous grating structure periodicity and with the same overall length since, in the first case, the periodicity need in each case be ensured only over a fraction of the overall length of the grating.

Alternatively or additionally, the light beam guidance means are designed to split the light beam into two or more beam elements for the same, desired frequency or wavelength, and to point these at the diffraction grating, such that they overlap entirely or partially in the grating longitudinal direction. In consequence, the overall light beam extent on the grating can be shortened in the grating longitudinal direction, so that it is possible to use a diffraction grating with a correspondingly shorter length, and if necessary with a sufficiently greater width. In this case as well, the production effort is simplified since a grating of shorter length than that of conventional arrangements is sufficient.

As one specific measure for this purpose, the light beam guidance means can be designed such that they offset the beam elements in the grating transverse direction and/or polarise them differently, and/or point them at the diffraction grating at different incidence angles, which correspond to different diffraction orders. In each of these cases, the overall length of the grating can be made shorter than that of a comparable conventional arrangement, as far as a factor which corresponds to the number of beam elements.

In a development of the invention according to Claim 2, the diffraction grating and light beam guidance means are designed such that the bandwidth narrowing limiting influence of the diffraction-limited angular resolution of the grating, which is dependent on the grating length, is no greater than that of the light beam divergence.

In a development of the invention according to Claim 3, the diffraction grating is formed from two or more grating elements, which are arranged alongside one another in the grating longitudinal direction, for the chosen frequency or wavelength.

In a development of the invention according to Claim 4, the light beam guidance means contain an optics unit which offsets a first beam element in the grating transverse direction, and an optics unit which offsets a second beam element in the grating longitudinal direction. This allows the incident light beam to be split into two or more beam elements, which strike the diffraction grating alongside one another in the grating transverse direction, for bandwidth narrowing at the same frequency or wavelength.

In a development of the invention according to Claim 5, the light beam guidance means contain a suitable optics unit in order to produce an s-polarised beam element and a p-polarised beam element from the light beam, with these beam elements being allowed to strike the diffraction grating such that they at least partially overlap in the grating longitudinal direction, in order to narrow them to the same, predetermined frequency or wavelength.

In a development of the invention according to Claim 6, the light beam guidance means contain an optics unit which uses one incident light beam to produce two or more beam elements which emerge at different angles, and to point these at the diffraction grating at incidence angles which are associated with different diffraction orders, with the beam elements at least partially overlapping in the grating longitudinal direction on the diffraction grating, resulting in bandwidth narrowing of the beam elements to the same frequency or wavelength.

Advantageous embodiments of the invention and conventional exemplary embodiments which are included for comparison purposes will be described in the following text and are illustrated in the drawings, in which:

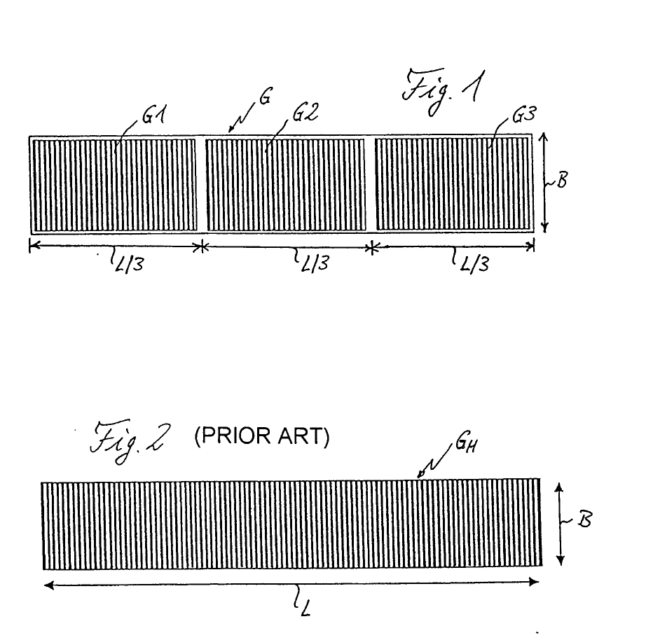

FIG. 1 shows a plan view of a diffraction grating according to the invention which can be used to narrow the bandwidth of a light beam and is formed from three grating elements,

FIG. 2 shows a plan view of a diffraction grating, as is conventionally used for narrowing the bandwidth of a light beam, with dimensions corresponding to those of the diffraction grating in FIG. 1,

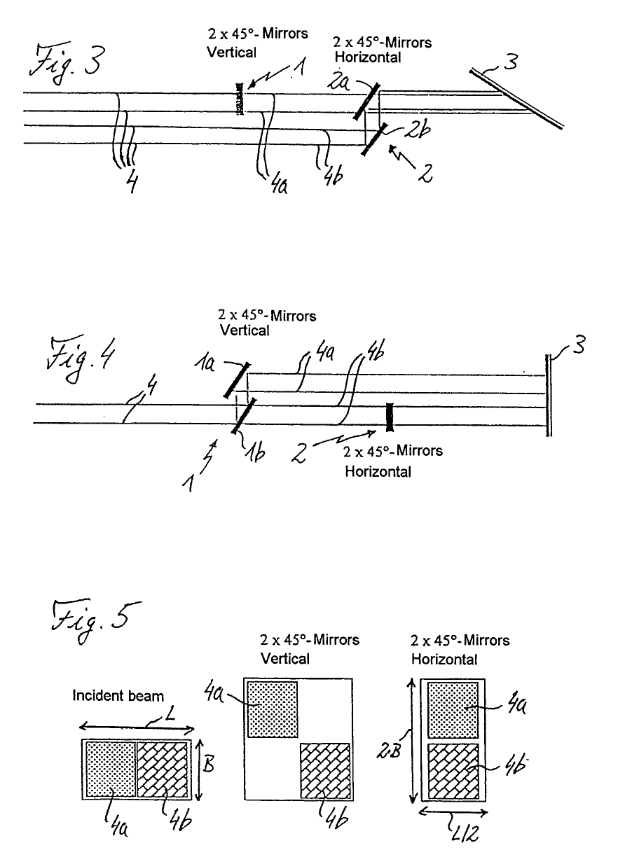

FIG. 3 shows a schematic plan view of a bandwidth narrowing apparatus according to the invention, which produces two beam elements and points them at the diffraction grating with a transverse offset,

FIG. 4 shows a schematic side view of the apparatus shown in FIG. 3,

FIG. 5 shows schematic beam cross-sectional views at three different points on the apparatus shown in FIGS. 3 and 4,

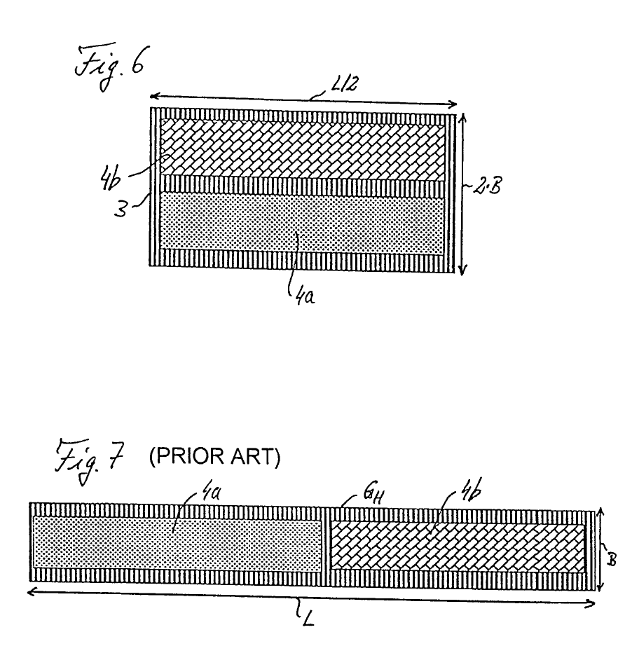

FIG. 6 shows a schematic illustration of two beam elements, which are transversely offset as shown in FIGS. 3 to 5, and are additionally widened in the grating longitudinal direction, striking the diffraction grating,

FIG. 7 shows a view corresponding to FIG. 6, but fore a conventionally used apparatus, for comparison purposes,

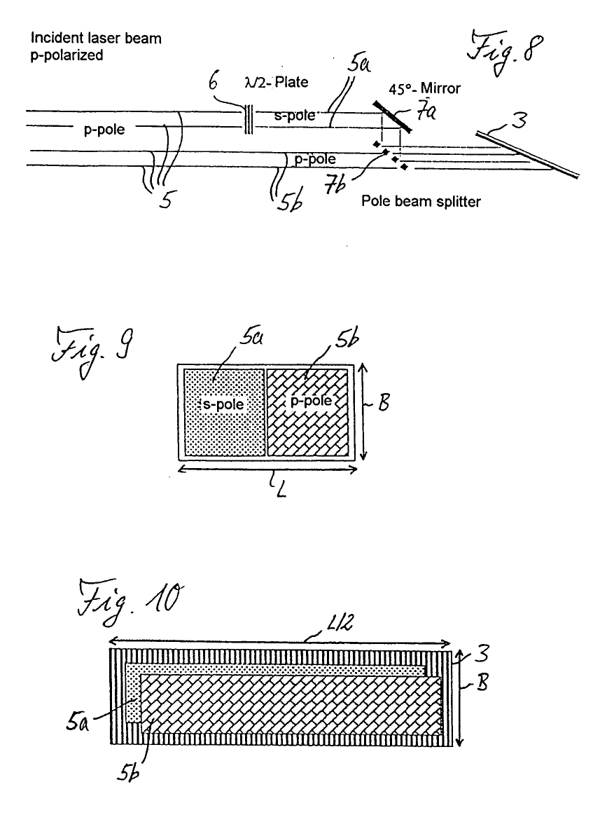

FIG. 8 shows a plan view corresponding to FIG. 3 of a bandwidth narrowing apparatus according to the invention, which produces two beam elements with different polarisation and points them at the diffraction grating, in a superimposed manner,

FIG. 9 shows a schematic beam cross-sectional view of the two different polarised beam elements in FIG. 8,

FIG. 10 shows a schematic plan view of the diffraction grating shown in FIG. 8, with the beam elements which strike the diffraction grating in a superimposed manner, have different polarisation and are widened in the grating longitudinal direction,

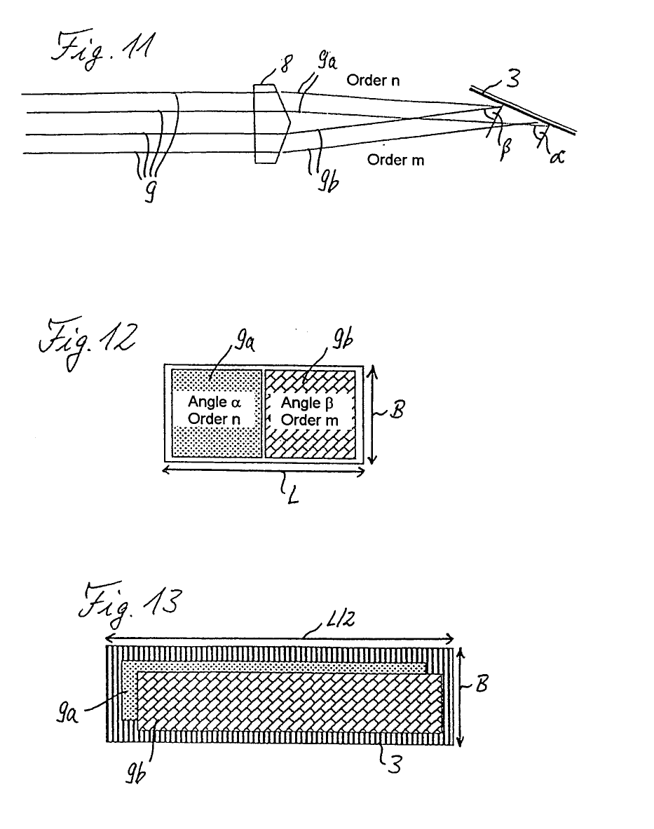

FIG. 11 shows a schematic plan view of a bandwidth narrowing apparatus according to the invention, which points two beam elements in a superimposed manner at the diffraction grating, at different incidence angles which are associated with different diffraction orders,

FIG. 12 shows a schematic beam cross-sectional view of the two beam elements from FIG. 11, and

FIG. 13 shows a schematic plan view of the diffraction grating from FIG. 11 with two beam elements which strike the diffraction grating in a superimposed manner and whose beams are widened in the grating longitudinal direction.

FIGS. 1 and 2 show schematic plan views of a diffraction grating according to the invention and of a conventional diffraction grating, respectively, as can be used in apparatuses for narrowing the bandwidth of a light beam, such as an excimer laser beam.

The conventionally used diffraction grating G_{H} shown in FIG. 2 contains a standard grating structure formed from a row of individual grating structure elements which typically comprise grating webs or grating lines and run along a direction which is referred to in the present document as the grating transverse direction, and which follow one another in a row along a direction which is referred to in the present document, as normal, as the grating longitudinal direction. This has a width B, which can be predetermined, in the transverse direction and a length L, which can be predetermined, in the longitudinal direction, with the diffraction-limited angular resolution of the grating being inversely proportional to the grating length L, as is known.

The diffraction grating G according to the invention shown in FIG. 1 is formed from three grating elements G1, G2, G3, which are arranged alongside one another in the grating longitudinal direction. In this grating G, only the structure elements of one respective grating element G1, G2, G3 need have a fixed phase relationship with the others, while this is not absolutely necessary for the grating structure elements of adjacent grating elements. If the diffraction grating G according to the invention has the same external dimensions as the conventional diffraction grating G_{H}, each of the grating elements G1, G2, G3, which are chosen to be of the same length, has a length L/3 of one third of the overall length L. In a corresponding way, the fixed phase relationship between the grating structure elements need be maintained in each case only over a reduced length of L/3 and not over the overall length L, thus making the manufacture of the grating G according to the invention as shown in FIG. 1 considerably simpler than that of the conventional grating G_{H} shown in FIG. 2. All the grating elements G1, G2, G3 are designed for bandwidth narrowing to the same frequency or wavelength which can be predetermined, for example by using identical grating structures.

Although this lack of maintenance of a fixed phase relationship between the grating structure elements of the different grating elements can admittedly lead to a sudden phase change for a coherent light wave which is reflected on the grating G, and can thus result in a reduction in the diffraction-limited grating resolution capability by the corresponding factor of three, this in general has a normally minor influence on the bandwidth of the light beam, however, since the beam divergence of the light beam which is reflected on the grating G is normally greater by at least the factor of three than the resolution capability of the conventional grating G_{H} and is thus still the determining parameter for the limiting of the bandwidth.

It is self-evident that, as an alternative to the illustrated grating G that is split into three parts, it is also possible to produce and use diffraction gratings which are formed from two or from more than three grating elements located alongside one another in the grating longitudinal direction, with the characteristics and advantages described above for the three-part grating G being applicable in a corresponding manner. In particular, these split gratings can also be produced more easily than conventional gratings G_{H}, with a full period over the overall length L, and with the same overall dimensions, since the periodicity of the grating structure elements need be maintained only over the respective grating element of length L/n where n is the number of grating elements.

FIGS. 3 to 7 show a further embodiment according to the invention of an apparatus for narrowing the bandwidth to a desired, predetermined frequency or wavelength with its components of interest here, and in comparison to a conventional apparatus of this type. As in all the other illustrated cases, the conventional components which may possibly be used in addition, such as a beam widening system, are not shown explicitly here, for the sake of simplicity.

FIGS. 3 and 4 show the apparatus in a plan view and in a side view, respectively. As can be seen from these figures, this apparatus contains light beam guidance means with two pairs 1, 2 of in each case two 45° deflection mirrors 1a, 1b and 2a, 2b, respectively. The two mirrors are arranged offset parallel in each mirror pair 1, 2, and the two mirror pairs 1, 2 are arranged one behind the other in the light beam path in front of a diffraction grating 3, which may, for example, be an Echelle grating in the Littrow configuration.

As can be seen from the schematic beam cross sections shown in FIG. 5, the first mirror pair 1, whose two mirrors 1a, 1b are arranged offset vertically, uses an incident light beam 4 to produce a first beam element 4a from the one, left-hand half of the incident beam 4, by offsetting this vertically from the first mirror pair 1, that is to say in the grating transverse direction, approximately by the height of the incident light beam 4. The other, right-hand half 4b of the incident light beam 4 is not influenced by the first mirror pair 1, and is offset horizontally by half the cross-sectional length L/2 of the incident light beam 4, and thus by the cross-sectional length of each of the two beam elements 4a, 4b, from the second mirror pair 2 as the second beam element 4b, for which purpose the two mirrors 2a, 2b of the second mirror pair 2 are arranged horizontally offset in an appropriate manner. For illustrative purposes, the two beam elements 4a, 4b in the schematic illustration in FIG. 5b are represented by different surface patterns.

Overall, in consequence, the incident light beam 4 with the assumed cross-sectional length L in the longitudinal direction of the diffraction grating 3 and with the assumed cross-sectional width B in the transverse direction of the grating 3 is split by the two mirror pairs 1, 2 into two beam elements 4a, 4b, which strike the diffraction grating 3 alongside one another, aligned in the grating transverse direction and completely overlapping in the grating longitudinal direction. In consequence, they assume only half the length L/2 there and thus twice the width 2B compared with a conventional arrangement, in which the incident beam 4 is pointed at the diffraction grating without any such splitting into beam elements and without any offsets between these beam elements. Bandwidth narrowing to the same, desired frequency or wavelength is carried out for both beam elements 4a, 4b.

FIGS. 6 and 7 once again show these relationships in comparison for an incident light beam, which is widened in the grating longitudinal direction, with a cross-sectional length L and a cross-sectional width B. In the conventional arrangement shown in FIG. 7, the left-hand half 4a of the light beam strikes the left-hand part of the integral, conventional diffraction grating G_{H}, and its right-hand half 4b strikes the right-hand part of the integral, conventional diffraction grating G_{H}. In consequence, the conventional grating G_{H} has a length L which corresponds to the cross-sectional length of the incident light beam, and a width which corresponds to the cross-sectional width B of the incident light beam.

In contrast to this, in the case of the apparatus according to the invention and as shown in FIGS. 3 and 4, the right-hand part 4b of the incident light beam strikes the diffraction grating 3 offset with respect to the left-hand part 4a, but aligned in the grating transverse direction, as is shown in FIG. 6, so that a reduced extent of the grating in the longitudinal direction is sufficient, corresponding to half the length L/2 of the conventionally used grating G_{H}. For this purpose, the grating 3 which is used according to the invention has twice the effective useful width B. This lengthening in the grating transverse direction is, however, not critical from the manufacturing point of view, since the individual grating structure elements just need to be designed to be correspondingly lengthened. The length shortening of the grating 3 by half, in contrast, saves a significant amount of production effort since, compared with the conventional grating G_{H}, this means that the periodicity of the grating structure elements now needs to be maintained only over half the length L/2. The halving of the diffraction-limited angular resolution of the grating 3 which is achieved by halving the length generally does not lead to any adverse effect on the bandwidth narrowing which can be achieved by the apparatus since, even then, the beam diversion is still generally the limiting factor.

It is self-evident that, in alternative embodiments, the incident light beam can be split into more than two beam elements which are then pointed successively at the diffraction grating in the grating transverse direction, partially or entirely overlapping in the grating longitudinal direction, once again for bandwidth narrowing to the same frequency or wavelength, so that it is possible to reduce the length of the grating up to a factor which corresponds to the number of beam elements.

FIGS. 8 to 10 show a further implementation according to the invention of a bandwidth narrowing apparatus, in which the length of the diffraction grating 3 which is used is reduced by producing two differently polarised beam elements 5a, 5b from one incident light beam 5, and by pointing them at the same effective diffraction grating area such that they overlap virtually completely at the same time in the grating longitudinal direction and in the grating transverse direction, so that their bandwidth can be narrowed to the same frequency or wavelength.

First of all, the entire incident light beam 5 is p-polarised by appropriate means. This is the case, for example, for a light beam which emerges from the laser amplification medium through an obliquely positioned outlet window at an inclination angle of less than or close to the Brewster angle and is passed via a prismatic beam widening system which, owing to the high polarisation dependency of the reflection losses on the prisms, leads to high-grade p-polarised laser light, as is known. The bandwidth narrowing apparatus in this example contains a λ/2 plate 6, which is introduced into the one, left-hand half of the incident light beam 5, so that this left-hand light beam element is transformed into an s-polarised, first beam element 5a, while the other, right-hand light beam element remains as a second, p-polarised beam element 5b. This situation is illustrated in FIG. 9 on the basis of a schematic beam cross section, with the two beam elements 5a, 5b once again being symbolized by different area patterns.

An adjacent pair of two 45° mirrors 7a, 7b, which are offset horizontally and parallel, then ensures complete, geometric superimposition of the two beam elements 5a, 5b, which in this way are pointed jointly at the same area of the diffraction grating 3. This is illustrated schematically in FIG. 10, with the two beam elements 5a, 5b being shown with their cross sections offset slightly in perspective, in order to make it possible to see them both. For the superimposition of the two beam elements 5a, 5b, the one mirror 7a reflects the s-polarised beam element 5b onto the other mirror 7b, which is in the form of a polarisation beam splitter, which reflects s-polarised light and allows p-polarised light to pass through it.

The superimposition of the two differently polarised beam elements 5a, 5b on the diffraction grating 3 once again means that it is sufficient for the latter to have half the extent in the grating longitudinal direction, compared with a grating used in a conventional manner, although the width in the grating transverse direction may remain unchanged in this example. In other words, the incident light beam 5 with the cross-sectional length L and the cross-sectional width B requires only one effective diffraction grating area of length L/2 in the grating longitudinal direction and with the width B in the grating transverse direction, as is shown in FIGS. 9 and 10, although this is not shown to scale in these figures. Once again, this results in the advantage that, compared to conventional arrangements, a diffraction grating which can be produced more easily and has a reduced length can be used for the bandwidth narrowing apparatus according to the invention.

FIGS. 11 to 13 show a further bandwidth narrowing apparatus according to the invention, which allows the use of a diffraction grating with a reduced length extent. In this example, the beam guidance means of the apparatus contain an optical element 8, which uses an incident light beam 9 to produce two beam elements 9a, 9b, which are pointed at the diffraction grating 3 at different incidence angles α, β, to be precise being virtually completely superimposed on the same effective diffraction grating area. The incidence angles α, β are specifically chosen such that they correspond to two different diffraction grating orders, for example of an nth order for the one beam element 9a and of an mth order for the other beam element 9b, where n≠m. This once again results in bandwidth narrowing to the same, predetermined frequency or wavelength for the two beam elements 9a, 9b. By way of example, an Axicon is suitable for use as an optical element such as this.

Once again, as is shown in FIGS. 12 and 13, which correspond to FIGS. 9 and 10 respectively, a grating with half the length L/2 in the grating longitudinal direction with the beam height of a corresponding effective grating width B can be used as a result of the splitting of the incident beam 9, with an assumed cross-sectional length L and an assumed cross-sectional width B, into the two beam elements 9a, 9b and their superimposition on the diffraction grating 3, which is simpler to produce than a full-periodic grating, used in a conventional manner, of length L. In this example, the two beam elements 9a, 9b are distinguished by different diffraction orders n, m for the diffraction on the grating 3, by choosing suitably different incidence angles α, β.

It is self-evident that, in alternative embodiments, the incident light beam can be split into more than two beam elements, which each have different incidence angles on the diffraction grating and which are associated with different diffraction orders, in order to narrow their bandwidth to the same frequency or wavelength.

As will be self-evident to those skilled in the art, so that it therefore does not require any further explanation, the beam path of the light after reflection on the grating, when using an Echelle grating in the Littrow configuration which is operated in reflection, corresponds to the opposite beam path of the incident light beam. Alternatively, the invention also covers apparatuses with different reflection gratings and with diffraction gratings which operate in transmission for wavelength and frequency selection.

As the illustrated exemplary embodiments explained above make clear, the invention allows the use of a diffraction grating with a comparatively short grating length for narrowing the bandwidth to a frequency or wavelength which can be predetermined, which diffraction grating can be produced correspondingly easily and which is thus generally not associated with any adverse effect on the achievable bandwidth, since this is limited predominantly by beam divergence. The invention can be usefully used, for example, in lasers which produce extremely narrowband UV radiation for wafer exposure in lithography systems.

It is self-evident that the invention also covers an apparatus for narrowing the bandwidth of a light beam which narrows the bandwidth to two or more different frequencies or wavelengths by appropriate multiplication of the components explained with respect to the exemplary embodiments above, for example by the use of two or more diffraction gratings which are selective for different wavelengths and are each formed from two or more grating elements, and/or by the use of two or more diffraction gratings which are selective for different wavelengths and of associated light beam guidance means, which split the light beam into two or more beam elements for at least one of these diffraction gratings and point these beam elements at the relevant diffraction grating such that they at least partially overlap in the grating longitudinal direction.

1. Apparatus for narrowing the bandwidth of a light beam for at least one frequency or wavelength which can be predetermined, in particular of a laser beam, having
a diffraction grating (G3) for the predetermined frequency or wavelength with grating structure elements which follow one another in a grating longitudinal direction and extend in a grating transverse direction, and
light beam guidance means, which point an incident light beam (4, 5, 9) at the diffraction grating,
characterized in that
the diffraction grating (G) is formed from two or more grating elements (G1, G2, G3) for the predetermined frequency or wavelength, and/or
the light beam guidance means are designed to split the light beam (4, 5, 9) into two or more beam elements (4a, 4b, 5a, 5b, 9a, 9b) and to point these at the diffraction grating (3) in an at least partially overlapping manner in the grating longitudinal direction, in which case they offset the beam elements in the grating transverse direction and/or polarise them differently and/or pass them at incidence angles (α, β), which correspond to different diffraction orders (n, m), to the diffraction grating in order to narrow the bandwidth with respect to the same predetermined frequency or wavelength.

2. The bandwidth narrowing apparatus as claimed in claim 1, characterized in that, in addition, the diffraction grating and the light beam guidance means are designed such that the bandwidth narrowing-limiting effect of the diffraction-limited resolution capability of the diffraction grating is less than or at most equal to the bandwidth narrowing-limiting effect of the divergence of the light beam.

3. Bandwidth narrowing apparatus according to claim 1 or 2, characterized in that, furthermore, the diffraction grating (G) is formed from two or more grating elements (G1, G2, G3), which are arranged alongside one another in the grating longitudinal direction, for bandwidth narrowing with respect to the same predetermined frequency or wavelength.

4. Bandwidth narrowing apparatus according to one of claims 1 to 3, characterized in that, furthermore, the light beam guidance means have an optics unit (1) for offsetting a first beam element (4a) in the grating transverse direction, and an optics unit (2) for offsetting a second beam element (4b) in the grating longitudinal direction.

5. Bandwidth narrowing apparatus according to one of claims 1 to 4, characterized in that, furthermore, the light beam guidance means have an optics unit (6, 7a, 7b) for producing an s-polarised beam element (5a) and a p-polarised beam element (5b) and for inputting the beam elements, such that they at least partially overlap in the grating longitudinal direction, to the diffraction grating (3) for bandwidth narrowing with respect to the same predetermined frequency or wavelength.

6. Bandwidth narrowing apparatus according to one of claims 1 to 5, characterized in that, furthermore, the light guidance means contain an optics unit (8) for splitting the light beam (9) into two or more beam elements (9a, 9b), which strike the diffraction grating at difference incidence angles (α, β), which correspond to difference diffraction orders (n, m), in such a manner that they at least partially overlap in the grating longitudinal direction, for bandwidth narrowing with respect to the same predetermined frequency or wavelength.
